(19) United States
(12) Patent Application Publication
(10) Pub. No.: US 2014/0160765 A1
(43) Pub. Date: Jun. 12, 2014

(54) PLANAR ILLUMINATION LIGHT SOURCE APPARATUS USING LIGHT EMITTER

(71) Applicants: Eiichi Sato, Hachioji-shi (JP); Ken Sato, Hachioji-shi (JP)

(72) Inventors: Eiichi Sato, Hachioji-shi (JP); Ken Sato, Hachioji-shi (JP)

(73) Assignee: OPTO DESIGN, INC., Hachioji-shi, Tokyo (JP)

(21) Appl. No.: 14/236,809

(22) PCT Filed: Aug. 3, 2012
(86) PCT No.: PCT/JP2012/069886

§ 371 Date: Feb. 3, 2014

(51) Int. Cl. F21K 99/00

(52) U.S. Cl. CPC F21K 9/50
USPC 362/307

(57) ABSTRACT

A planar illumination light source apparatus comprises: a point light source having strong directivity; a casing having a bottom surface section with a hole for attaching the point light source, and side surface reflection sections perpendicularly provided from edge sides of the bottom surface section; a light transmitting reflection plate facing the bottom surface section and supported by the side surface reflection sections; and a diffusion plate provided so as to be opposed to a surface of the light transmitting reflection plate that is far from the point light source. The light transmitting reflection plate is formed so as to have a higher light transmissivity and lower light reflectivity as being farther away from the point light source. A light emitter is attached to a region irradiated with radiation light from the point light source.

### TECHNICAL FIELD

The present invention relates to a planar illumination light source apparatus using a light emitter, and more particularly to a planar illumination light source apparatus that can produce illumination light of various colors by using a light transmitting reflection plate having a light emitter- containing layer while using a monochrome light-emitting diode (hereinafter referred to as an “LED”), and can substantially uniformly illuminate the whole illuminating range.

### BACKGROUND ART

Over recent years, research and development of light-emitting diodes have been advancing at a rapid pace, with various types of LEDs being developed, productized, and used in a wide range of fields. Due to their features of low power consumption, long life, and compactness, LEDs have long been used as operation indicator lights for electronic equipment and the like. These LEDs have been much used in, for example, backlights for liquid crystal panels, various kinds of display boards, electronic signboards, decorative illumination devices and so forth, and have now come to be used in the field of illumination. In the illumination field, they are used for automobile headlights and taillights, in planar illumination devices incorporating a plurality of LEDs, in illumination devices that incorporate LEDs inside a tube and can be used in the same manner as fluorescent tubes, and light-bulb illumination devices incorporating LEDs, for example.

However, it is difficult to use LEDs solely for illumination because LEDs have strong light directivity. For this reason, a variety of ideas are adopted to use LEDs for illumination applications. For example, as related-art planar illumination light source devices that use LEDs as light sources and are for obtaining illuminating light with planar, uniform illuminance distribution, light source devices as follows are well known: light source devices including light transmitting resin provided on the emitting surface of light so that the light is diffused; and light source devices including reflection means provided on the emitting surface of light so that the light is multiply reflected (see Patent Document 1 below).

As shown in FIG. 9, a planar illumination light source apparatus 50 disclosed in Patent Document 1 below includes: a highly-directional point light source 51 such as an LED; a casing 55 having a bottom plane 52 and a side plane 53 of particular sizes and formed with an opening 54, the casing 55 having, at an inner wall surface thereof, an inside reflection part and a side reflection part that reflect or irregularly reflect light; and light radiation side reflection means 56 that covers the opening 54 and transmits, reflects, and irregularly reflects light. The casing 55 is provided with the point light source 51 arranged at the center of the bottom plane 52 thereof. The radiation side reflection means 56 has a central reflection part 57 in a particular area immediately above the point light source 51, and an outward reflection part 58 arranged at an outer periphery of the central reflection part 57. The outward reflection part 58 is formed of a reflection member having a particular reflectivity that partially transmits, reflects, or irregularly reflects a part of light. The central reflection part 57 is formed of a light transmissive reflection part having a reflectivity higher than the reflectivity of the outward reflection part 58.

This planar illumination light source apparatus 50 allows light having strong directivity that is emitted from the LED to be multiple-reflected between the radiation side reflection means 56, which has the central reflection part 57 and the outward reflection part 58, and the inner plane of the casing 55, and emits transmitted light having a uniform light intensity from the radiation side reflection means 56.

### RELATED ART DOCUMENT

### Patent Document

[Patent Document 1] Japanese Patent No. 4280283

[Patent Document 2] Re-Publication of PCT International Publication No. 2004/097294

### DISCLOSURE OF INVENTION

### Problem to be Solved by the Invention

The planar illumination light source apparatus disclosed in Patent Document 1 above achieves the advantageous effect of providing uniform illumination light over a large area without increasing the thickness in the emission direction of the LED, even though a point light source having strong directivity is used such as a single LED In the planar illumination light source apparatus disclosed in Patent Document 1 above, however, the color of illumination light is limited by the emission color of the LED. For applications requiring light of a wide variety of colors, it is necessary to change the kind of LEDs for each color requirement or to provide a casing accommodating a plurality of LEDs emitting different colors. This leads to an increase in costs.

As shown in FIG. 10, Patent Document 2 above discloses an invention of a light-emitting planar body-structured body 60 that includes: an LED light source 61 emitting ultraviolet radiation or near-ultraviolet radiation; and a planar body 62 arranged on the front side of the LED point light source 61. The planar body 62 is formed of a light-transmitting resin molding containing dispersed therein at least one kind of phosphors and light-storing bodies together with light-transmitting inorganic particles. The invention of the light-emitting planar body-structured body 60 disclosed in Patent Document 2 above can achieve an advantageous effect of selectively radiating light of a variety of colors by changing the kind of phosphors and light-storing bodies contained in the planar body 62.

In the invention of the light-emitting planar body-structured body 60 disclosed in Patent Document 2 above, the planar body 62 is formed of a light-transmitting resin molding that contains dispersed therein at least one kind of phosphors and light-storing bodies together with light-transmitting inorganic particles. To prevent uneven light emission over a large area with a reduced thickness, therefore, a plurality of LED light sources 61 have to be arranged approximately at every 60 mm, for example, even when light-diffusing ultraviolet LEDs are used as the LED light sources 61.

In view of the above-mentioned problems, the present invention provides a planar illumination light source apparatus that can substantially uniformly illuminate the whole illuminating range and can change the colors of illumination light without replacing LEDs, with a small number of point light sources attached with respect to an illuminating region, and with small power consumption.

### Means for Solving Problem

According to an aspect of the present invention, a planar illumination light source apparatus includes: a point light source having strong directivity; a casing having a bottom surface section provided with a hole for attaching the point light source, and side surface reflection sections perpendicularly provided from edge sides of the bottom surface section; a removable light transmitting reflection plate facing the bottom surface section and supported by the side surface reflection sections; and a diffusion plate provided so as to be opposed to a surface of the light transmitting reflection plate that is far from the point light source. The light transmitting reflection plate is formed so as to have a higher light transmissivity and a lower light reflectivity as being farther away from the point light source. A light emitter that absorbs light from the point light source and emits light is disposed in a region irradiated with radiation light from the point light source.

In the planar illumination light source device of the first aspect of the invention, the light transmitting reflection plate is formed so that the portion thereof facing the point light source has the highest light reflectivity and the lowest light transmissivity while the light transmissivity increases and the light reflectivity decreases as being farther away from the point light source. Therefore, uniform illumination light can be obtained from the whole surface of the light transmitting reflection plate although the point light source has strong directivity. Furthermore, the light emitter that absorbs light from the point Tight source and emits light is disposed in a region irradiated with radiation light from the point light source. Therefore, the color of illumination light from the LED can be changed at low cost by changing as appropriate light transmitting reflection plates with light emitters of different colors installed thereto.

According to a second aspect of the invention, in the planar illumination light source apparatus according to the first aspect, the light emitter is disposed on the side of the light transmitting reflection plate facing the point light source. According to a third aspect of the invention, in the planar illumination light source apparatus according to the first aspect, the light emitter is disposed over a region having a particular radius around a point on the optical axis of the point light source, on the side of the light transmitting reflection plate facing the point light source.

In the planar illumination light source apparatus according to the second and third aspects of the invention, the reduction in the region in which the light emitter is disposed can reduce the quantity of light absorbed by the light emitter and reduce optical loss. In addition, light radiated from the point light source and light emitted from the light emitter can be mixed to produce illumination light of a desired color tone.

According to a fourth aspect of the invention, in the planar illumination light source apparatus according to any one of the first to third aspects, the light emitter is a fluorophore.

The planar illumination light source apparatus according to the fourth aspect of the invention can mix light radiated from the point light source and light emitted from the fluorophore to produce color illumination of a desired color tone.

According to a fifth aspect of the invention, in the planar illumination light source apparatus according to the first or second aspect, the light emitter is a phosphor.

The planar illumination light source apparatus according to the fifth aspect of the invention using a phosphor as the light emitter can moderate the degree of flicker of light caused in illumination using an AC power supply.

According to a sixth aspect of the invention, in the planar illumination light source apparatus according to the first aspect, the light emitter is provided over the whole of at least one surface of the diffusion plate.

In the planar illumination light source apparatus according to the sixth aspect of the invention, substantially all the light from the point light source is transmitted through the light emitter section. Thus, the planar illumination light source apparatus emits light of high purity only from the light emitter.

According to a seventh aspect of the invention, in the planar illumination light source apparatus according to the fourth aspect, the fluorophore is a yellow fluorophore, and the point light source is a blue light-emitting diode.

The planar illumination light source apparatus according to the seventh aspect can mix blue light radiated from the blue LED and yellow light emitted from the fluorophore to produce white light.

According to an eighth aspect, in the planar illumination light source apparatus according to the fourth aspect, the point light source is an ultraviolet light-emitting diode or a near-ultraviolet light-emitting diode.

The use of an ultraviolet light-emitting diode or a near-ultraviolet light-emitting diode improves the light emitting efficiency of the fluorophore, and therefore provides a bright planar illumination light source apparatus. It is preferable that an ultraviolet or near-ultraviolet radiation absorption filter layer should be formed over the outermost surface of the planar illumination light source apparatus in order to ensure improvement in safety.

According to a ninth aspect of the invention, in the planar illumination light source apparatus according to any one of the first to eighth aspects, the casing and the light transmitting reflection plate are formed using an ultrafine foamed reflection member.

With the planar illumination light source device of the ninth aspect of the invention, an ultrafine foamed reflection member, which has high light reflectivity and low light transmissivity, is used as a member for forming the casing and the light transmitting reflection plate, thus enabling the light emitted from the point light source to be utilized without loss and with high efficiency.

### BRIEF DESCRIPTION OF DRAWINGS

FIG. 1 is a perspective view of a planar illumination light source apparatus according to a first embodiment of the invention.

FIG. 2 is an exploded perspective view of the planar illumination light source apparatus according to the first embodiment of the invention.

FIG. 3 is a top view of a light transmitting reflection plate used in the planar illumination light source apparatus according to the first embodiment of the invention.

FIG. 4A is a sectional view along IVA-IVA line in FIG. 1, and FIG. 4B is a sectional view of the planar illumination light source apparatus in a modification of the first embodiment.

FIG. 5 is a plan view of the light transmitting reflection plate used in the planar illumination light source apparatus according to the first embodiment of the invention, as viewed from the point light source side.

FIG. 6 is a perspective view of a planar illumination light source apparatus according to a second embodiment of the invention.

FIG. 7 is a sectional view along VII-VII line in FIG. 6.

FIG. 8 is a sectional view of a planar illumination light source apparatus according to a third embodiment of the invention.

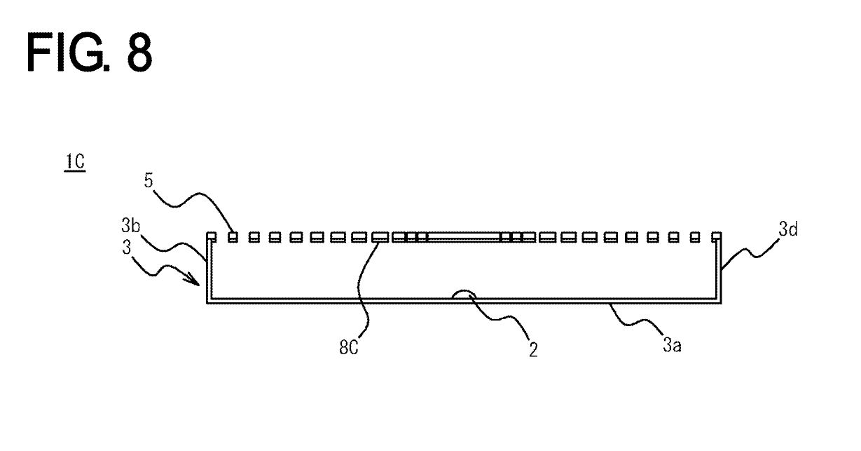

FIG. 9 is a side-sectional view of a planar illumination light source apparatus disclosed in Patent Document 1.

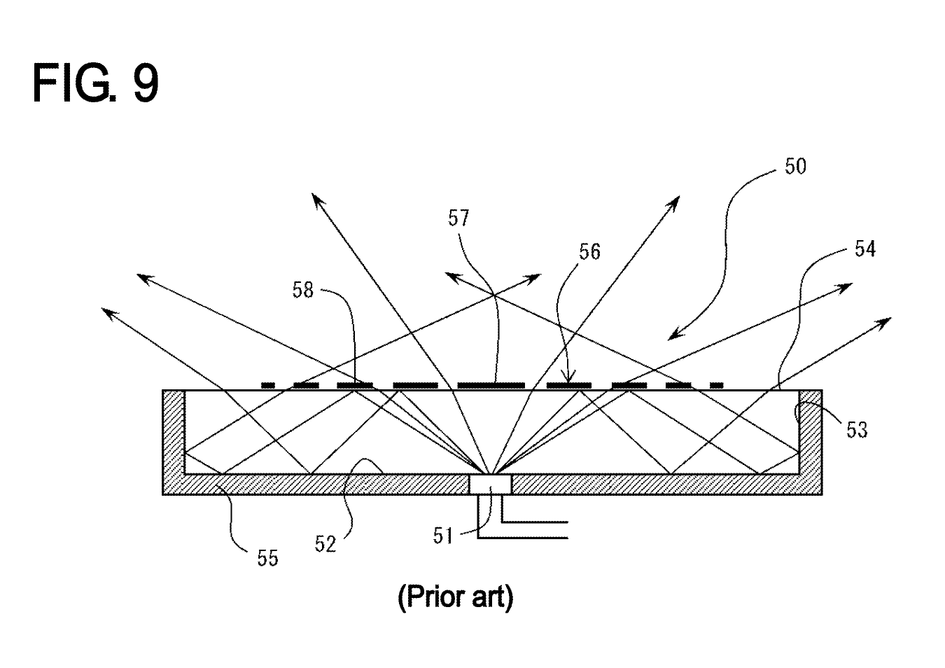

FIG. 10 is a side-sectional view of a light emitting planar body-structured body disclosed in Patent Document 2.

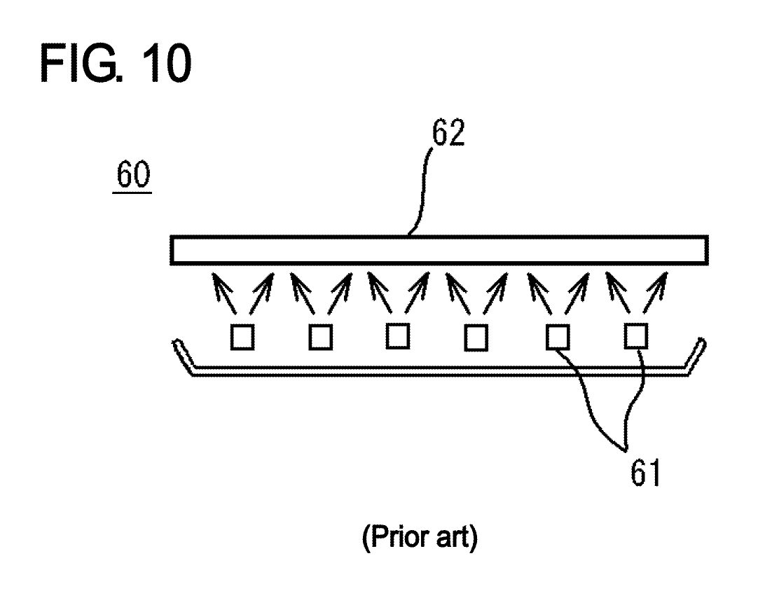

### BEST MODES FOR CARRYING OUT THE INVENTION

Embodiments for cal lying out the invention will now be described with reference to the accompanying drawings. It should be noted that these embodiments are intended as examples of planar illumination light source apparatuses in order to carry out the technical concepts of the invention, and not as limiting the invention to these embodiments, and thus they can be equally applied to other embodiments falling within the scope and spirit of the appended claims.

### First Embodiment

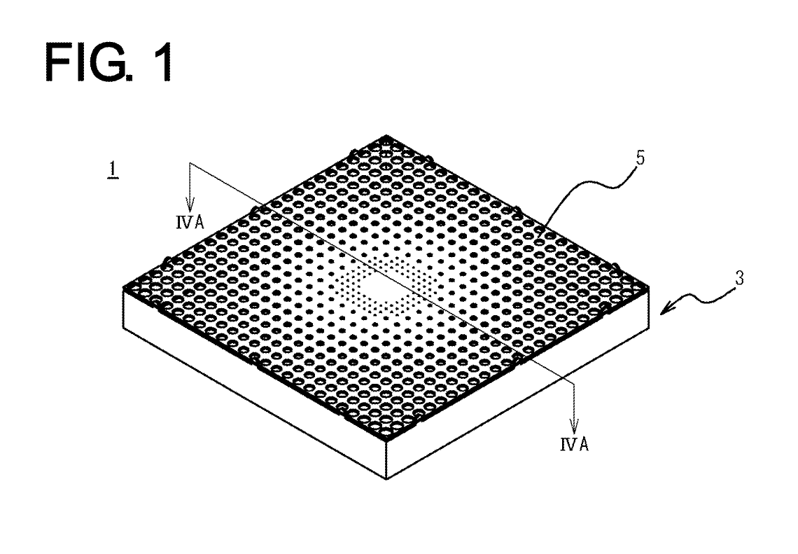

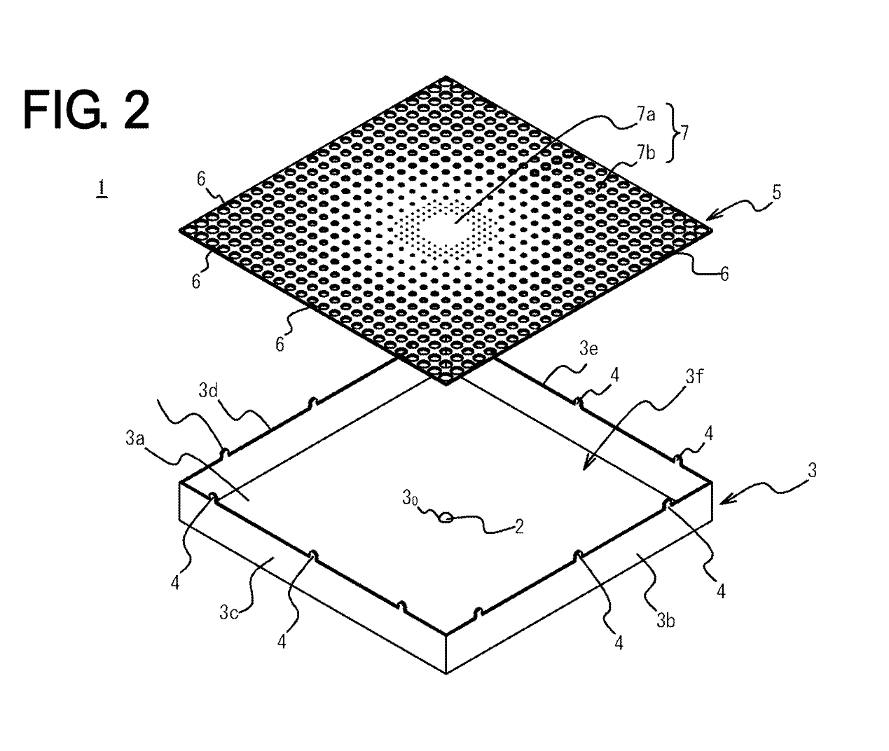

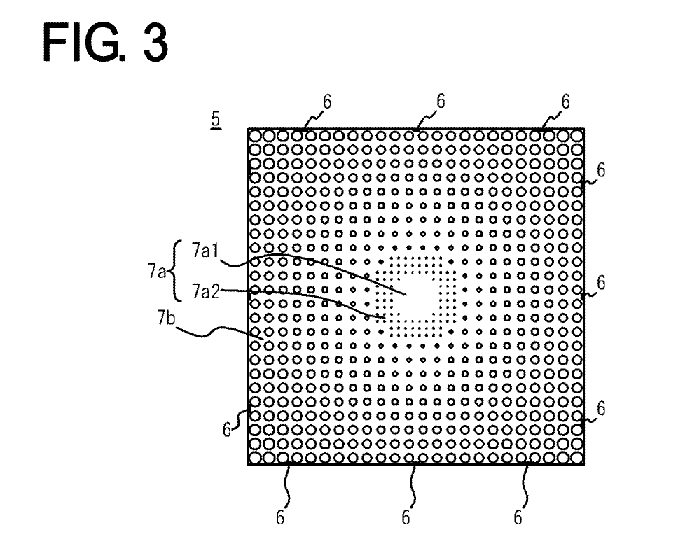

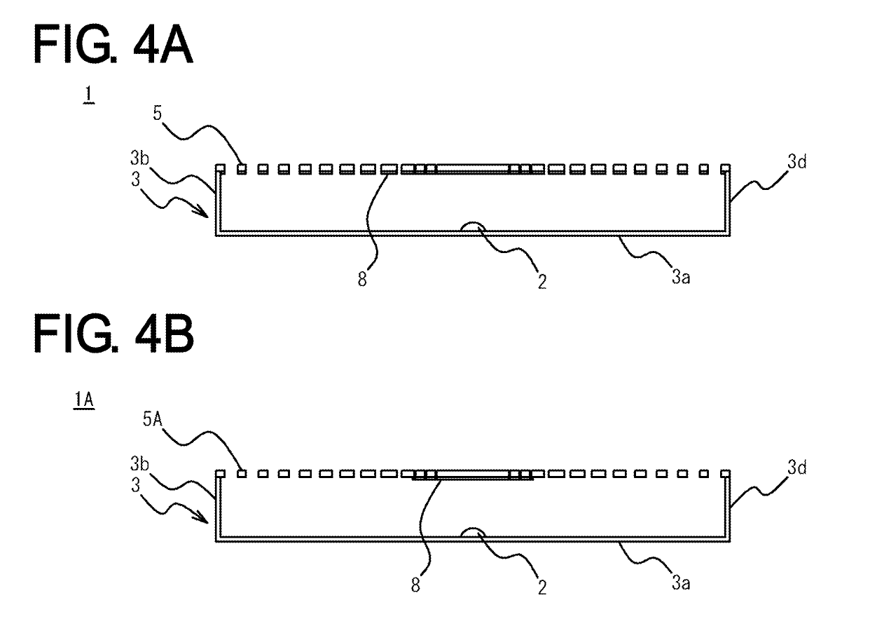

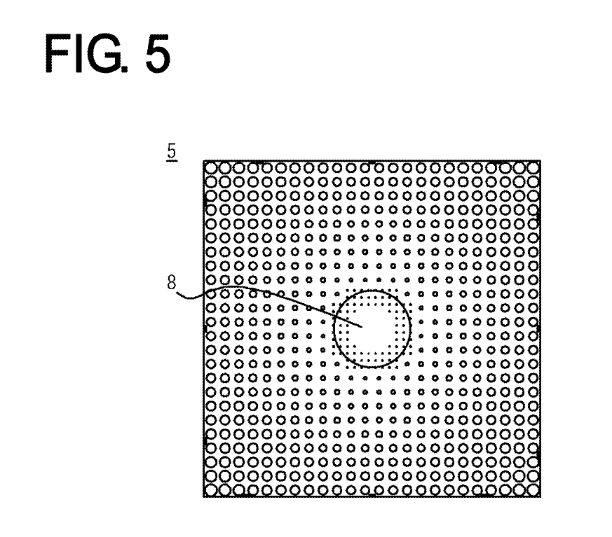

First, a planar illumination light source apparatus according to a first embodiment of the invention will be described with reference to FIG. 1 to FIG. 5. FIG. 1 is a perspective view of the planar illumination light source apparatus according to the first embodiment of the invention. FIG. 2 is an exploded perspective view of the planar illumination light source apparatus according to the first embodiment of the invention. FIG. 3 is a top view of a light transmitting reflection plate used in the planar illumination light source apparatus according to the first embodiment of the invention. FIG. 4A is a sectional view along IVA-IVA line in FIG. 1, and FIG. 4B is a sectional view of the planar illumination light source apparatus in a modification of the first embodiment. FIG. 5 is a plan view of the light transmitting reflection plate used in the planar illumination light source apparatus according to the first embodiment of the invention, as viewed from the point light source side.

This planar illumination light source apparatus 1 includes: a casing 3 having a square bottom surface section 3a having each side of, for example, about 200 mm, side plate sections 3b, 3c, 3d, and 3e that have a height of 8 mm and are perpendicularly provided from the sides of the bottom surface section 3a, and an opening 3f formed in a surface facing the bottom surface section 3a; and a light transmitting reflection plate 5 attached so as to close the opening 3f of the casing 3. The bottom surface section 3a has a hole 3₀ at the center thereof, through which a point light source 2 is disposed. The point light source 2 is fixed to a substrate (not illustrated) fixed to the casing 3, and further connected to an external power supply or other units. In the first embodiment, the point light source 2 is an ultraviolet light-emitting diode having one light-emitting element or a plurality of light-emitting elements.

The casing 3 is formed of a material having a high light reflectivity, for example, a material such as an ultrafine foamed light reflection plate having a light reflectivity of 98%, a light transmissivity of 1%, and a light absorbance of 1%. Light from the point light source 2 can be reflected on the inner wall surface of the casing 3 with a high light reflectivity to be used effectively. A lighter weight of the ultrafine foamed light reflection plate can prevent the weight of the planar illumination light source apparatus 1 from being increased. The easy availability and relatively low cost of the ultrafine foamed light reflection plate can prevent an increase in the cost for producing the planar illumination light source apparatus 1.

The side plate sections 3b to 3e each are provided with three pawls 4. The pawls 4 are passed through locking holes 6 provided in the light transmitting reflection plate 5 to engage the light transmitting reflection plate 5 with the casing 3. The engagement of the pawls 4 and the locking holes 6 enables easy attachment and removal of the light transmitting reflection plate 5.

The light transmitting reflection plate 5 has a particular thickness and is formed of a material having a high light reflectivity and a low light transmissivity such as ultrafine foamed reflection member. In the present embodiment, the thickness is 1 mm. This enables the light from the point light source 2 to be reflected with high reflectivity and be utilized with good efficiency. Furthermore, a certain amount of light is transmitted also at the portion directly above the point light source 2, so that the portion directly above the point light source 2 will not be excessively dark. Since the ultrafine foamed reflection member is easily available at relatively low cost, the manufacture cost can be curbed. As shown in FIG. 3, the light transmitting reflection plate 2 includes a central light transmitting reflection section 7a at the portion directly above the point light source 2, and an outer light transmitting reflection section 7b around the central light transmitting reflection section 7a.

A central portion 7a1 is provided in the central part of the central light transmitting reflection section 7a, that is, at the portion directly above the point light source 2. The central portion 7a1 has high light reflectivity and reflects the intense light emitted from the point light source 2. This reflected light is further multiple-reflected by the side surface sections 3b to 3e, the bottom surface section 3a, and the light transmitting reflection plate 5. The light reflectivity of the central portion 7a1 is determined as appropriate depending on selection of material of the light reflection plate and processing (for example, formation of half-slits and adjustment of the sheet thickness) of such material, whereby the light can be utilized with good efficiency.

A peripheral portion 7a2 is provided around the periphery of the central portion 7a1, that is, at the boundary with the outer light transmitting reflection section 7b. The peripheral portion 7a2 has a small hole and is designed to have the second highest light reflectivity behind the central portion 7a1, but on the other hand to allow part of the light to pass through. Due to the use of the small hole, while having a certain light transmissivity, the light transmitting reflection plate does not directly transmits the light emitted from the point light source. A slit or the like may be used instead of the small hole.

In the outer light transmitting reflection section 7b round apertures 7b1 are formed at particular intervals. The diameter of the apertures 7b1 increases steadily with a larger distance outward from the central light transmitting reflection section 7a. Additionally, the slits and the apertures 7b1 are designed so as to transmit the light that is emitted from the point light source 2 and reflected once or more times by the side surface sections 3b to 3e, the bottom surface section 3a, and the light transmitting reflection plate 5. Instead of round apertures, slits in a concentric ring-form or rectangular form can be provided, with their widths increasing with a larger distance outward from the central light transmitting reflection section 7a. By disposing the light transmitting reflection plate 5 having a structure as described above so as to face the point light source 2, a uniform illuminance distribution can be obtained even if an LED with strong light directivity is used as the light source.

A fluorophore 8 is applied onto the whole of a surface of the light transmitting reflection plate 5 that faces the point light source 2. In the present embodiment, the color of the fluorophore 8 is yellow. Light radiated from the point light source 2 is transmitted through the fluorophore 8 at least once, reflected in the casing 3, and radiated to the outside of the casing 3 as white light. Although the color of the fluorophore 8 is yellow in the present embodiment, a fluorophore of another color can be used to change the color of illumination light.

As shown in FIG. 4B and FIG. 5, the area onto which the fluorophore is applied may be limited. The range onto which the fluorophore 8 is applied in the light transmitting reflection plate 5A is within a circle having a radius of 4 cm around a point on the optical axis of the point light source 2. The point light source 2 used in the present embodiment is an LED having strong light directivity. Therefore, the fluorophore 8 is applied only to the area where direct light having a directional angle of up to 45 degrees is reflected on the light transmitting reflection plate 5A. Thus, about 70% of the direct light from the point light source 2 is directly radiated on the fluorophore 8, so that the color of illumination light can be changed. The reduction of the region onto which the fluorophore 8 is applied, as in the present modification, can reduce the quantity of light absorbed by the fluorophore 8 and reduce optical loss. This can also reduce the fluorophore 8 for use and reduce the manufacturing cost.

### Second Embodiment

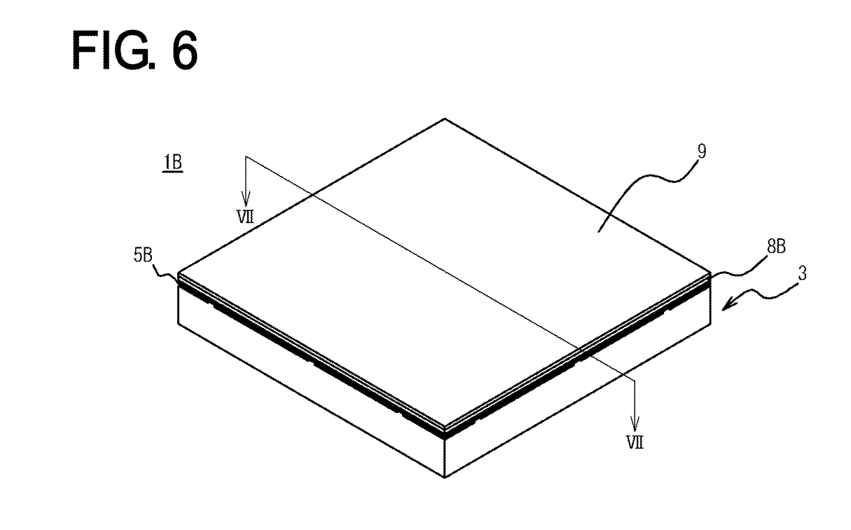

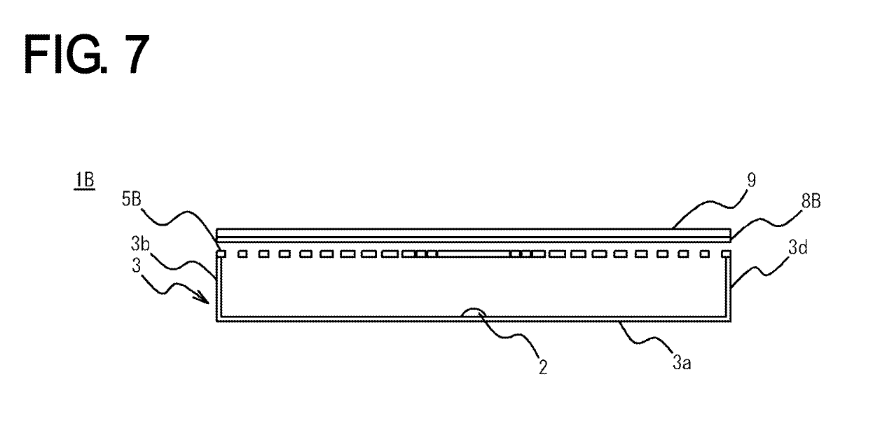

A planar illumination light source apparatus according to a second embodiment of the invention will be described with reference to FIG. 6 and FIG. 7. FIG. 6 is a perspective view of the planar illumination light source apparatus according to the second embodiment of the invention. FIG. 7 is a sectional view along VII-VII line in FIG. 6.

In this planar illumination light source apparatus 1B according to the second embodiment of the invention, common parts to those in the first embodiment are not shown in the drawings or a suffix “B” is added to the same reference numerals in the drawings, and a detailed description thereof will be omitted.

In the second embodiment, the planar illumination light source apparatus 1B includes a diffusion plate 9 disposed at a particular distance from the light transmitting reflection plate 5. A fluorophore 8B is applied onto the whole of a surface of the diffusion plate 9 that faces a light transmitting reflection plate 5B. No fluorophore is applied onto the light transmitting reflection plate 5B. Ultraviolet rays with uniform illuminance radiated from the light transmitting reflection plate 5B are transmitted through the fluorophore 8B to become white light, which is transmitted through the diffusion plate 9, thereby increasing the uniformity of illuminance.

A planar illumination light source apparatus according to a third embodiment of the invention will be described with reference to FIG. * is a sectional view of the planar illumination light source apparatus according to the third embodiment of the invention.

In this planar illumination light source apparatus IC according to the third embodiment of the invention, common parts to those in the first embodiment are not shown in the drawings, and a detailed description thereof will be omitted.

In the present invention, an AC power supply circuit (not shown in the drawings) is attached. The AC power supply naturally provides a non-constant voltage. The LED illumination apparatus using the AC power supply inevitably causes flicker of light because the brightness of the LED varies with such voltage. To reduce flicker, it is necessary to reduce the difference between the maximum voltage and the minimum voltage or to reduce the difference in brightness of illumination The reduction of the difference between the maximum voltage and the minimum voltage can be achieved by installing a capacitor in the power supply circuit. The installation of a capacitor, however, increases the size of the circuit. Reducing the size costs much or poses any other problems.

To reduce the difference in brightness of illumination, in the planar illumination light source apparatus IC according to the third embodiment of the invention, a phosphor 8C is applied onto the whole of a surface of the light transmitting reflection plate 5 that faces the point light source 2. The phosphor, after being irradiated with light, emits light for a period from microseconds to milliseconds. The phosphor 8C emits light due to irradiation of light at a time of the maximum voltage, which can keep a certain illuminance even when the voltage drops and can moderate flicker. That is, the use of the phosphor can moderate a temporal difference in illuminance.

### EXPLANATIONS OF LETTERS OR NUMERALS

1, 1A, 1B planar illumination light source apparatus
2 point light source
3 casing
5, 5A, 5B light transmitting reflection plate
8, 8B fluorophore
8C phosphor
9 diffusion plate

1. A planar illumination light source apparatus comprising:
a point light source having strong directivity;
a casing having a bottom surface section provided with a hole for attaching the point light source, and side surface reflection sections perpendicularly provided from edge sides of the bottom surface section;
a removable light transmitting reflection plate facing the bottom surface section and supported by the side surface reflection sections; and
a diffusion plate provided so as to be opposed to a surface of the light transmitting reflection plate that is far from the point light source,
the light transmitting reflection plate being formed so as to have a higher light transmissivity and a lower light reflectivity as being farther away from the point light source, and
a light emitter that absorbs light from the point light source and emits light being disposed in a region irradiated with radiation light from the point light source.

2. The planar illumination light source apparatus according to claim 1, wherein the light emitter is disposed over the whole surface on the side of the light transmitting reflection plate facing the point light source.

3. The planar illumination light source apparatus according to claim 1, wherein the light emitter is disposed over a region having a particular radius around a point on the optical axis of the point light source, on the side of the light transmitting reflection plate facing the point light source.

4. The planar illumination light source apparatus according to claim 1, wherein the light emitter is a fluorophore.

5. The planar illumination light source apparatus according to claim 1, wherein the light emitter is a phosphor.

6. The planar illumination light source apparatus according to claim 1, wherein the light emitter is provided over the whole of at least one surface of the diffusion plate.

7. The planar illumination light source apparatus according to claim 4, wherein the fluorophore is a yellow fluorophore, and the point light source is a blue light-emitting diode.

8. The planar illumination light source apparatus according to claim 4, wherein the point light source is an ultraviolet light-emitting diode or a near-ultraviolet light-emitting diode.

9. The planar illumination light source apparatus according to claim 1, wherein the casing and the light transmitting reflection plate are formed using an ultrafine foamed reflection member.
